(19) United States
(12) Patent Application Publication
(10) Pub. No.: US 2007/0077826 A1
(43) Pub. Date: Apr. 5, 2007

(54) COMPUTER CASE

(75) Inventor: Tsung-Kan Cheng, Taipei (TW)

Correspondence Address: PAI PATENT & TRADEMARK LAW FIRM, 1001 FOURTH AVENUE, SUITE 3200, SEATTLE, WA, 98154, US

(73) Assignee: POSIFLEX INC., Taipei Hsien (TW)

(21) Appl. No.: 11/382,920

(22) Filed: May 11, 2006

(30) Foreign Application Priority Data
Oct. 5, 2005 (TW) 94217253

(51) Int. Cl. H01R 13/514

(52) U.S. Cl. 439/701

(57) ABSTRACT

A computer case includes a lower and an upper cover pivotally connected at a front end to each other via two shafts. The lower and upper covers are provided near two lateral rear ends with an elastic fastening mechanism each for detachably locking a rear end of the lower and upper covers when they are closed to each other. A set of computer equipment is mounted to inner surfaces of the lower and upper covers. When the upper cover is pivotally lifted from the lower cover to fully open the computer case, the computer equipment can be easily accessed to facilitate repair or maintenance thereof.

### RELATED APPLICATIONS

The present application is based on, and claims priority from, Taiwan Application Serial Number 94217253, filed Oct. 5, 2005, the disclosure of which is hereby incorporated by reference herein in its entirety.

### FIELD OF THE INVENTION

The present invention relates to a computer case, and more particularly, to a computer case that can be easily assembled and opened to facilitate repair or maintenance of computer equipment mounted therein.

### BACKGROUND OF THE INVENTION

Generally, a conventional computer case includes a cabinet with five sides, an open front, and a front cover screwed to the open front of the cabinet. The cabinet defines an internal space, in which necessary equipment and components, such as power supply, main board, hard disk, etc., are sequentially mounted from bottom to top. The conventional computer case is not conveniently assembled and does not enable an operator to conveniently repair or maintain the components mounted therein.

To assemble the conventional computer case, the operator has to use a tightening tool, such as a screwdriver, to mount and tighten a large number of screws one by one to connect the front cover to the open front of the cabinet. A lot of labor and time are required to complete the assembling of the conventional computer case. When it is necessary to repair or maintain the components mounted in the computer case, it takes the operator even more time to loosen the screws and separate the front cover from the cabinet and then tighten the screws to assemble the front cover to the cabinet again. Moreover, the screws might be lost during the process of removing and mounting the front cover.

Since the cabinet has five sides to define a small internal space, the necessary components must be sequentially stacked in the cabinet from bottom to top. When any one of the stacked components is dismounted from or remounted to the cabinet, other components immediately located above and below that component are inevitably affected to cause great inconvenience to the operator. Moreover, even with the front cover removed from the cabinet, the internal space of the cabinet is still in a half-closed state, which hinders the operator from conveniently visually checking and manually handling the components sequentially stacked in the cabinet.

### SUMMARY OF THE INVENTION

It is therefore a primary object of the present invention to provide a computer case that can be easily assembled and opened to simplify and facilitate the repair or maintenance of computer equipment mounted in the computer case.

To achieve the above and other objects, the computer case according to the present invention includes a lower and an upper cover pivotally connected at a front end to each other via two shafts, so that the upper cover can be turned about the shafts to lift from or close onto the lower cover. The lower cover includes a bottom plate, a lower front panel upwardly extended from a front edge of the bottom plate, and two lower lateral walls upwardly extended from two lateral edges of the bottom plate. The upper cover includes a top plate, an upper front panel downwardly extended from a front edge of the top plate, and two upper lateral walls downwardly extended from two lateral edges of the top plate. The lower and upper covers are provided near rear ends of each pair of lower and upper lateral walls with an elastic fastening mechanism for detachably locking a rear end of the lower and upper covers when they are closed to each other. A set of computer equipment is mounted on inner surfaces of the lower and upper covers. When the upper cover is pivotally lifted from the lower cover to fully open the computer case, the computer equipment can be easily accessed to facilitate repair or maintenance thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded perspective view of a computer case according to the present invention;

FIG. 2 is a partially assembled perspective view of the computer case of FIG. 1 with an upper cover thereof in an opened position;

FIG. 3 is a partially assembled perspective view of the computer case of FIG. 1 with the upper cover thereof in a closed position;

FIG. 4 is an enlarged sectional view of the circled area A of FIG. 3;

FIG. 5 is an enlarged sectional view of the circled area B of FIG. 3;

FIG. 6 is a fully assembled perspective view of the computer case of FIG. 1;

FIG. 7 is an enlarged sectional view taken along line C-C of FIG. 6;

FIG. 8 is a front view of a first hard disk box mounted in the computer case of the present invention; and

FIG. 9 is an assembled sectional view showing the mounting of a second hard disk box in the computer case of the present invention.

### DETAILED DESCRIPTION OF THE PREFERRED EMBODIMENTS

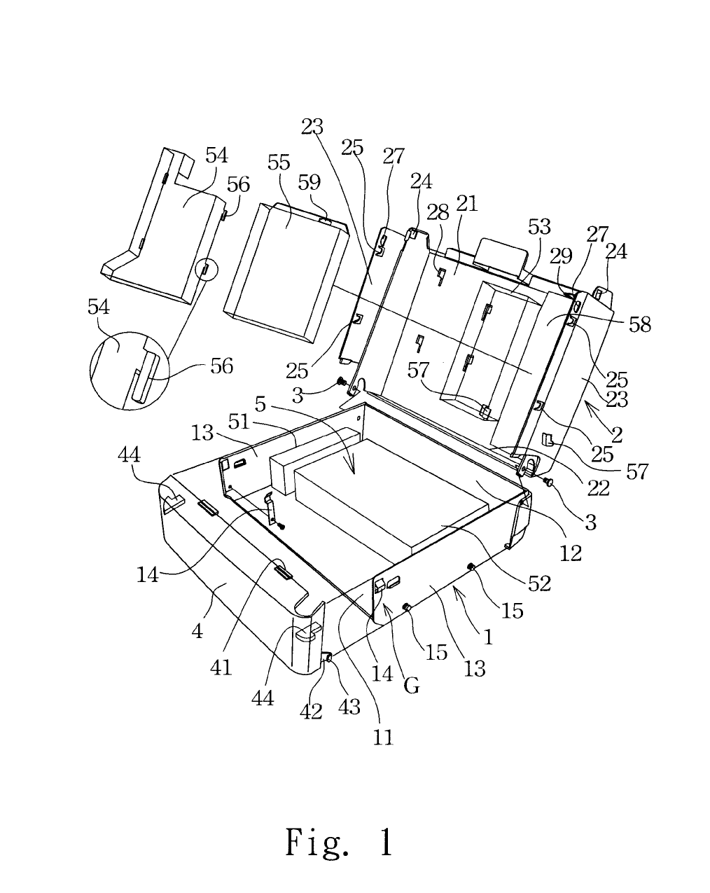

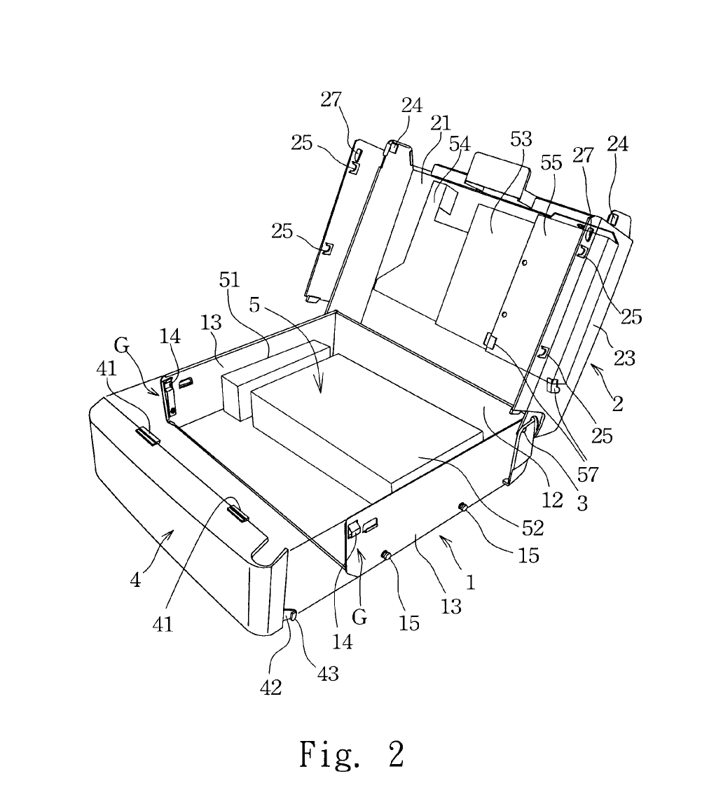

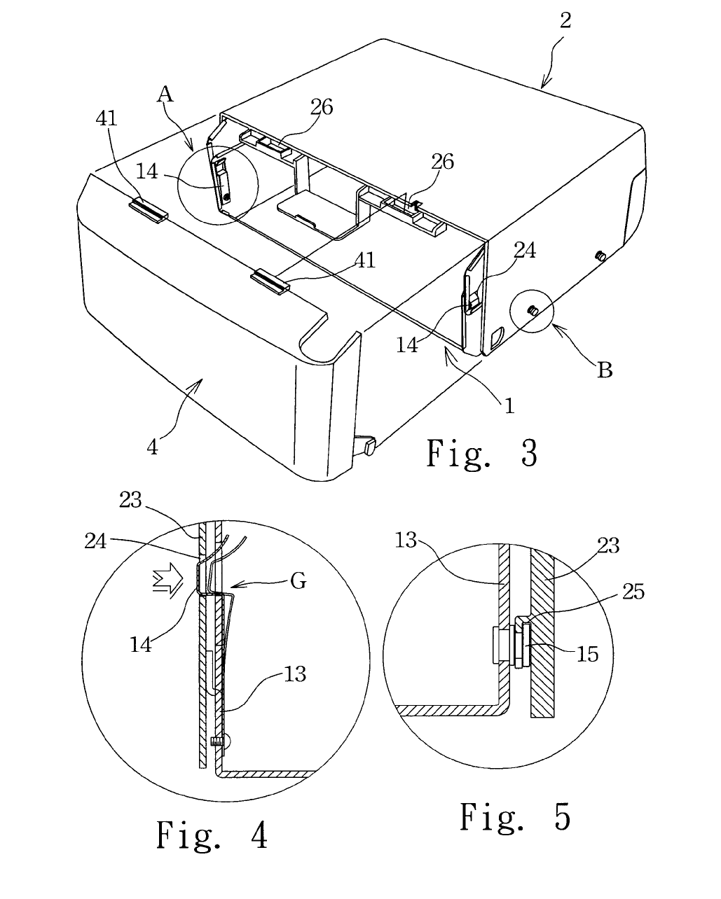

Reference is made to FIG. 1 that is an exploded perspective view of a computer case according to the present invention, and to FIGS. 2 and 3 that are partially assembled perspective views of the computer case of FIG. 1 in an opened and a closed state, respectively. As shown, the computer case of the present invention mainly includes a lower cover 1 and an upper cover 2.

The lower cover 1 includes a bottom plate 11, a lower front panel 12 upwardly extended from a front edge of the bottom plate 11, and two lower lateral walls 13 separately upwardly extended from two lateral edges of the bottom plate 11.

The upper cover 2 includes a top plate 21, an upper front panel 22 downwardly extended from a front edge of the top plate 21, and two upper lateral walls 23 separately downwardly extended from two lateral edges of the top plate 21.

The upper cover 2 and the lower cover 1 are pivotally connected to each other near front ends of the lower and upper lateral walls 13, 23 via two shafts 3, so that the upper cover 2 is upwardly or downwardly pivotable about the shafts 3 to open or close the lower cover 1.

An elastic fastening mechanism G is provided near rear ends of each pair of the lower and the upper lateral walls 13, 23. When the upper cover 2 and the lower cover 1 are closed together, the elastic fastening mechanism G automatically locks up a rear end of the lower and upper covers 1, 2.

Reference is also made to FIG. 4 that is an enlarged sectional view of the circled area A of FIG. 3. In a preferred embodiment, the elastic fastening mechanism G includes a flat spring 14 having an outwardly projected head mounted near a front edge of each lower lateral wall 13 of the lower cover 1, and a retaining hole 24 formed near a front edge of each upper lateral wall 23 of the upper cover 2 corresponding to the outwardly projected head of the flat spring 14. When the upper cover 2 is closed onto the lower cover 1, the outwardly projected head of the flat spring 14 elastically extends through the corresponding retaining hole 24 to lock the upper cover 2 to the lower cover 1.

It is also possible to provide the flat spring 14 and the retaining hole 24 on the upper cover 2 and the lower cover 1, respectively. That is, the flat spring 14 may be provided near the front edge of each upper lateral wall 23, and the retaining hole 24 may be correspondingly provided near the front edge of each lower lateral wall 13 to provide the same locking effect.

Reference is made to FIG. 5 that is an enlarged sectional view of the circled area B of FIG. 3. The lower cover 1 is provided on an outer surface of each lower lateral wall 13 with at least one sideward projected pin 15; and the upper cover 2 is provided on an inner surface of each upper lateral wall 23 with at least one receiving seat 25 corresponding to the at least one pin 15. When the upper cover 2 and the lower cover 1 are closed together, the pins 15 and the receiving seats 25 abut against and engage with one another to ensure a stable connection of the lower and upper covers 1, 2 to each other.

Again, the pins 15 and the receiving seats 25 may be exchanged in their positions. That is, it is also possible to provide the pins 15 on the inner surfaces of the upper lateral walls 23, and the receiving seats 25 on the outer surfaces of the lower lateral walls 13 to provide the same stable connecting effect.

Although not shown in the drawings, the lower and/or upper cover 1, 2 are provided at a rear edge with a rear panel. When the lower cover 1 and the upper cover 2 are closed together, the rear panel closes a rear open side defined by the lower and upper covers 1, 2. However, as shown in the illustrated embodiment of the present invention, the rear panel may be a rear decorative panel 4 detachably connected to the rear open side of the closed lower and upper covers 1, 2.

The rear decorative panel 4 is provided at an upper edge with at least one insertion plate 41, and the upper cover 2 is correspondingly provided on the top plate 21 with at least one insertion recess 26 adapted to engage with the insertion plate 41. The rear decorative panel 4 is also provided at two lateral ends with an elastic arm 42 each (see FIG. 2). The elastic arm 42 is provided on an outer side with a sideward protruded key 43, and each of the two upper lateral walls 23 is provided at a position corresponding to the key 43 with a key hole 27 for detachably engaging with the key 43. Further, as can be seen from FIG. 1, the rear decorative panel 4 is provided on each of two lateral inner surfaces with a stop 44. When the rear decorative panel 4 is assembled to the rear open side defined by the mutually closed lower and upper covers 1, 2, the stops 44 are immediately located behind inner surfaces of the two flat springs 14 provided near the front ends of the two lower lateral walls 13, preventing the flat springs 14 from unexpectedly loosening from the retaining holes 24 on the two upper lateral walls 23.

A set of computer equipment 5, including, for example, a power supply 51, a main board 52, a battery box 53, a first hard disk box 54 for, for example, a 2.5″ hard disk, and a second hard disk box 55 for, for example, a 3.5″ hard disk, is mounted to inner surfaces of the bottom plate 11 and/or the top plate 21. For instance, the power supply 51 and the main board 52 may be mounted to the inner surface of the bottom plate 11, while the battery box 53, the first hard disk box 54, and the second hard disk box 55 are mounted to the inner surface of the top plate 21.

To enable easy access to the hard disks, the first and the second hard disk box 54, 55 are connected to the top plate 21 via an easy-on/off structure.

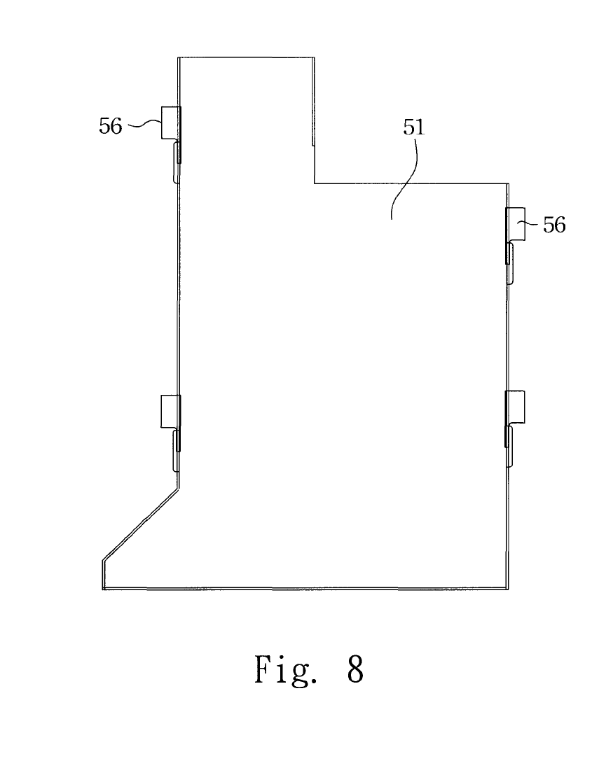

Reference is made to FIG. 8 along with FIGS. 1 and 2. The first hard disk box 54 is provided at two lateral sides with a laterally outward extended tab 56 each, and the top plate 21 is provided on the inner surface with retaining slots 28 corresponding to the two tabs 56, such that the tabs 56 and the retaining slots 28 are easily detachably engaged with one another.

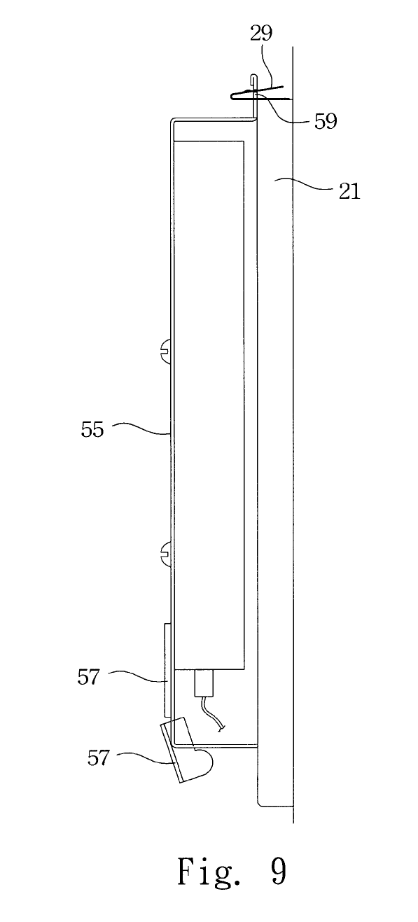

Reference is made to FIG. 9 along with FIGS. 1 and 2. Two holding plates 57 are provided at predetermined positions on the battery box 53 and the inner surface of one upper lateral wall 23. These holding plates 57 together with the inner surface of the top plate 21 define a receiving space 58 between them; and the top plate 21 is provided on the inner surface near a rear edge thereof with an elastic hooking plate 29, which is vertically protruded from the top plate 21. The second hard disk box 55 is provided at a position corresponding to the elastic hooking plate 29 with a retaining hole 59. When the second hard disk box 55 is mounted in the receiving space 58, the retaining hole 59 is easily engaged with the elastic hooking plate 29 to detachably connect the second hard disk box 55 to the top plate 21.

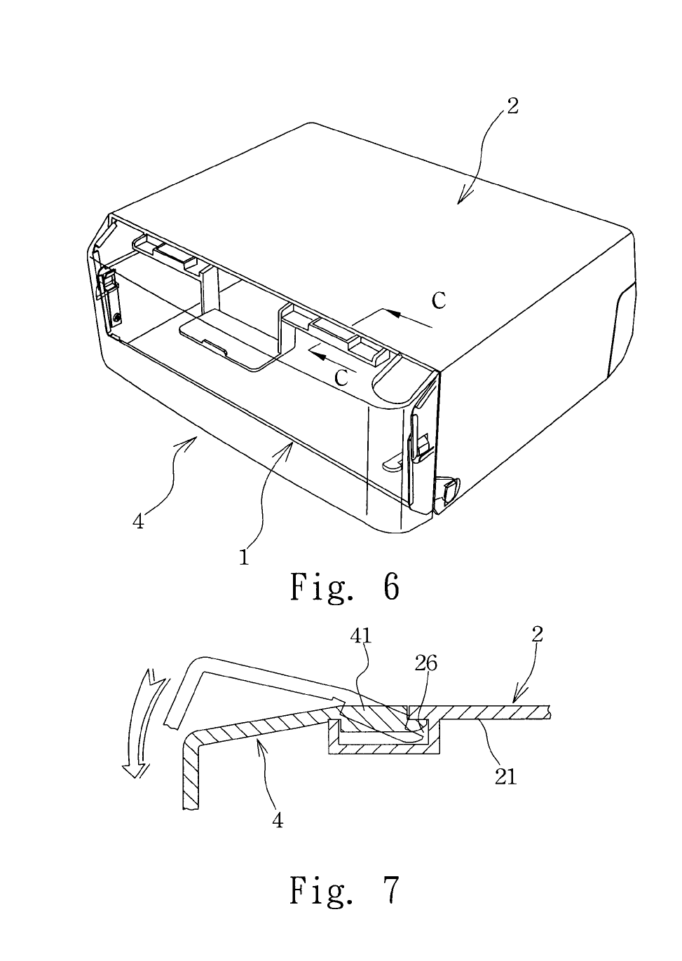

To assemble the computer case of the present invention, the upper cover 2 is first closed to the lower cover 1 by downwardly turning the upper cover 2 about the two shafts 3. At this point, the retaining holes 24 on the upper cover 2 engage with the outwardly projected heads of the flat springs 14 on the lower cover 1 (see FIG. 4), and the receiving seats 25 on the upper cover 2 are abutted against and engaged with the sideward projected pins 15 on the lower cover 1 (see FIG. 5). Then, as shown in FIGS. 6 and 7, the rear decorative panel 4 is assembled to the rear open side of the closed lower and upper covers 1, 2 by inserting the at least one insertion plate 41 on the rear decorative panel 4 into the corresponding insertion recess 26 on the upper cover 2, and engaging the laterally protruded keys 43 on the two elastic arms 42 at two lateral ends of the rear decorative panel 4 with the two key holes 27 on the upper cover 2 to complete the assembling of the computer case of the present invention.

When it is necessary to repair or maintain the computer equipment 5 inside the computer case, the keys 43 are first depressed to disengage them form the key holes 27, and the rear decorative panel 4 can be easily removed from the closed lower and upper covers 1, 2. Thereafter, the outwardly projected heads of the flat springs 14 are depressed to disengage them from the retaining holes 24, and the upper cover 2 can be easily turned about the two shafts 3 and lifted from the lower cover 1. Then, both the lower and the upper covers 1, 2 are in a fully opened state, and the computer equipment 5 can be conveniently accessed to facilitate necessary repair and/or maintenance thereof.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A computer case, comprising:
a lower cover including a bottom plate, a lower front panel upwardly extended from a front edge of said bottom plate, and two lower lateral walls upwardly extended from two lateral edges of said bottom plate; and
an upper cover including a top plate, an upper front panel downwardly extended from a front edge of said top plate, and two upper lateral walls downwardly extended from two lateral edges of said top plate,
wherein said lower and said upper cover are pivotally connected to each other at front ends of said lower and upper lateral walls via two shafts, such that said upper cover is upwardly or downwardly pivoted about said two shafts to lift from or close onto said lower cover, and said lower and said upper cover are provided near rear ends of each pair of said lower and upper lateral walls with an elastic fastening mechanism for locking a rear end of said lower and said upper cover when said upper cover is closed onto said lower cover; and
a set of computer equipment being mounted to inner surfaces of said top plate and/or said bottom plate.

2. The computer case as claimed in claim 1, wherein said elastic fastening mechanism includes a flat spring provided on each said lower lateral wall at a predetermined position, and said flat spring having an outwardly projected head; and a retaining hole provided on each said upper lateral wall at a position corresponding to said outward projected head of said flat spring; and said outward projected heads of said flat springs on said lower lateral walls being detachably engaged with said retaining holes on said upper lateral walls when said upper cover is closed onto said lower cover.

3. The computer case as claimed in claim 1, wherein said elastic fastening mechanism includes a flat spring provided on each said upper lateral wall at a predetermined position, and said flat spring having an outward projected head; and a retaining hole provided on each said lower lateral wall at a position corresponding to said outwardly projected head of said flat spring; and said outwardly projected heads of said flat springs on said upper lateral walls being detachably engaged with said retaining holes on said lower lateral walls when said upper cover is closed onto said lower cover.

4. The computer case as claimed in claim 1, wherein said lower cover is provided on an outer surface of each said lower lateral wall with at least one sideward projected pin; and said upper cover is provided on an inner surface of each said upper lateral wall with at least one receiving seat corresponding to said at least one sideward projected pin, such that when said upper cover and said lower cover are closed together, said sideward projected pins are abutted against and engaged with said receiving seats.

5. The computer case as claimed in claim 1, wherein said upper cover is provided on an inner surface of each said upper lateral wall with at least one sideward projected pin; and said lower cover is provided on an outer surface of each said lower lateral wall with at least one receiving seat corresponding to said at least one sideward projected pin, such that when said upper cover and said lower cover are closed together, said sideward projected pins are abutted against and engaged with said receiving seats.

6. The computer case as claimed in claim 1, wherein said set of computer case equipment includes at least a power supply, a main board, a battery box, a first hard disk box, and a second hard disk box.

7. The computer case as claimed in claim 6, wherein said power supply and said main board are mounted to an inner surface of said bottom plate of said lower cover.

8. The computer case as claimed in claim 6, wherein said battery box, said first hard disk box, and said second hard disk box are mounted to an inner surface of said top plate of said upper cover.

9. The computer case as claimed in claim 8, wherein said first hard disk box is provided at two lateral sides with a laterally outwardly extended tab each, and said top plate is provided on the inner surface with retaining slots corresponding to said two tabs, and said tabs are adapted to detachably engage with said retaining slots.

10. The computer case as claimed in claim 8, wherein two holding plates are provided at predetermined positions on said battery box and the inner surface of one said upper lateral wall, and said holding plates together with the inner surface of said top plate define a receiving space therebetween, wherein said top plate is provided on the inner surface near a rear edge thereof with an elastic hooking plate, which is vertically protruded from said top plate, and said second hard disk box is provided at a position corresponding to said elastic hooking plate with a retaining hole, whereby when said second hard disk box is mounted in said receiving space defined by said holding plates and said top plate, said retaining hole on said second hard disk box is engaged with said elastic hooking plate on said top plate to quickly detachably connect said second hard disk box from said top plate.

11. The computer case as claimed in claim 1, further comprising a rear decorative panel for closing a rear open side of said mutually closed upper and lower covers.

12. The computer case as claimed in claim 11, wherein said rear decorative panel is provided at an upper edge with at least one insertion plate, and said upper cover is correspondingly provided on said top plate with at least one insertion recess adapted to engage with said insertion plate, wherein said rear decorative panel is also provided at each lateral end with an elastic arm having a sideward protruded key provided on an outer side thereof, and each of said two upper lateral walls is provided at a position corresponding to said key of said elastic arm with a key hole for detachably engaging with said key.

13. The computer case as claimed in claim 12, wherein said rear decorative panel is provided on two lateral inner surfaces with a stop each, which is located immediately behind an inner side of each said elastic fastening mechanism to prevent said elastic fastening mechanism from unexpectedly loosening from a locked state.
